(19) United States
(12) Patent Application Publication
(10) Pub. No.: US 2018/0173614 A1
(43) Pub. Date: Jun. 21, 2018

(54) TECHNOLOGIES FOR DEVICE INDEPENDENT AUTOMATED APPLICATION TESTING

(71) Applicant: INTEL CORPORATION, Santa Clara, CA (US)

(72) Inventors: Jiong GONG, Shanghai (CN); Yun WANG, Shanghai (CN); Haihao SHEN, Shanghai (CN)

(21) Appl. No.: 15/576,491

(22) PCT Filed: Jun. 26, 2015
(86) PCT No.: PCT/CN2015/082542

§ 371 Date: Nov. 22, 2017

(51) Int. Cl. G06F 11/36

(52) U.S. Cl. CPC G06F 11/3664; G06F 3/04817; G06F 11/3688

(57) ABSTRACT

Technologies for device-independent application testing include a host computing device and one or more test computing devices. The host computer device records user interface events generated by an application of the test computing device and video data indicative of the display interface of the application. The host computing device detects user interface objects in the video data that correspond to user interface events using a computer vision algorithm, which may include image feature detection or optical character recognition. The host computing device generates an object-based test script that identifies the user interface object and a user interaction. The host computing device may identify the user interface object in the display interface of an application executed by a different test computing device using the computer vision algorithm. The host computing device performs the specified user interaction on the detected user interface object. Other embodiments are described and claimed.

### BACKGROUND

Currently, a wide number and variety of applications (“apps”) are available for many different computing platforms. However, as the number of applications and the number of computing devices that may execute those applications increase, application validation and testing becomes an increasingly difficult problem. Application validation and testing may require a tester to design a test case that mimics real-world human interaction with an application. In some cases, the tester may be required to validate the same application against multiple computing devices with different form factors (e.g., screen size, aspect ratio, etc.).

Typical application testing systems may have difficulty scaling to support testing an application on a large number of different devices. For example, certain application testing systems can record a script describing user inputs to the application with a hard-coded coordinate system. However, those coordinate-based systems may not scale across devices with different form factors. As another example, certain application testing systems may allow a tester to programmatically write a script based on manipulating operating-system-level user interface controls, such as the UIAutomator framework provided by Android™. However, programmatic user interface scripting is typically much more labor-intensive than recording a script, and cannot be used to test applications based on a different underlying operating system and/or user interface framework. In particular, many games do not use system-provided user interface frameworks and thus may not be tested with programmatic user interface scripting.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for device-independent automated application testing;

FIG. 2 is a simplified block diagram of at least one embodiment of various environments that may be established by the system of FIG. 1;

FIG. 3 is a simplified flow diagram of at least one embodiment of a method for recording an object-based test script that may be executed by a computing device of FIGS. 1 and 2;

FIG. 4 is a simplified flow diagram of at least one embodiment of a method for playing back an object-based test script that may be executed by the computing device of FIGS. 1 and 2; and

FIG. 5 is a schematic illustration of a method for device-independent application testing that ay be performed by the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

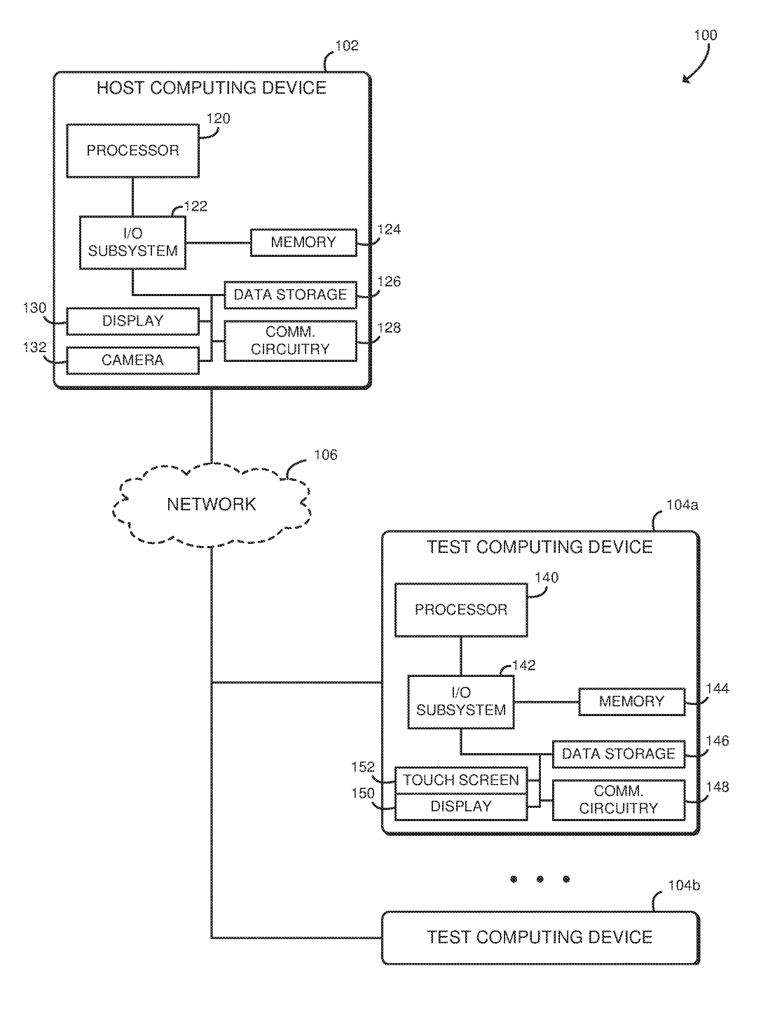

Referring now to FIG. 1, in an illustrative embodiment, a system 100 for device-independent application testing includes a host computing device 102 and one or more test computing devices 104, which may be in communication over a network 106. The illustrative system 100 includes two test computing devices 104a, 104b; however it should be understood that in some embodiments the system 100 may include a different number of test computing devices 104. In use, as described in more detail below, the host computing device 102 connects to the test computing device 104a and starts an application test session. During the application test session, a user operates an application of the test computing device 104a, for example performing user interface interactions to test the functionality of the application. The host computing device 102 records user interface events and a video of the display interface generated by the test computing device 104a during the application test session. The host computing device 102 analyzes the video data using a computer vision algorithm to identify user interface objects (e.g., buttons, menu items, etc.) associated with the user interface events and generates an object-based test script based on the application test session. After generating the test script, the host computing device 102 may start an application test session with another test computing device 104b. The test computing devices 104a, 104b may have different form factors, different operating systems, or otherwise differ. The host computing device 102 plays back the object-based test script by analyzing the display interface of the test computing device 104b to identify the user interface objects and perform scripted actions on the user interface objects. Thus, the system 100 may facilitate automated testing of a variety of different test computing devices 104 while requiring the user to record only a single application test session. Additionally, compared to programmatic test scripting, the system 100 may improve efficiency by allowing script recording, and may be usable to test computing devices 104 that support different scripting environments (e.g., test computing devices 104 with different underlying operating systems and/or user interface frameworks).

The host computing device 102 may be embodied as any type of computation or computer device capable of performing the functions described herein, including, without limitation, a computer, a desktop computer, a workstation, a laptop computer, a notebook computer, a tablet computer, a mobile computing device, a wearable computing device, a network appliance, a web appliance, a distributed computing system, a processor-based system, and/or a consumer electronic device. As shown in FIG. 1, the host computing device 102 illustratively includes a processor 120, an input/output subsystem 122, a memory 124, a data storage device 126, and communication circuitry 128. Of course, the host computing device 102 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the host computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the host computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processors 120, the memory 124, and other components of the host computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the host computing device 102 may be embodied as any communication circuit, device, or collection thereof, capable of enabling communications between the host computing device 102, the test computing devices 104, and/or other remote devices either directly or over the network 106. The communication circuitry 128 may be configured to use any one or more communication technology (e.g., wired or wireless communications) and associated protocols (e.g., direct serial communication, USB communication, Ethernet, Bluetooth®, WiMAX, etc.) to effect such communication,

Additionally, the host computing device 102 may also include a display 130 and a camera 132. The display 130 may be embodied as any type of display capable of displaying digital information such as a liquid crystal display (LCD), a light emitting diode (LED), a plasma display, a cathode ray tube (CRT), or other type of display device. As described below, the display 130 may be used to display a graphical user interface or other information to the user of the host computing device 102. Additionally, in some embodiments, the host computing device 102 may include a touch screen coupled to the display 130. The touch screen may be used to record user input that is similar to user input of the test computing device 104, as described further below.

The camera 132 may be embodied as a digital camera or other digital imaging device integrated with the host computing device 102 or otherwise communicatively coupled thereto. The camera 132 includes an electronic image sensor, such as an active-pixel sensor (APS), e.g., a complementary metal-oxide-semiconductor (CMOS) sensor, or a charge-coupled device (CCD). The camera 132 may he used to capture images of the user interface presented by one or more of the test computing devices 104 including, in some embodiments, capturing still images or video images.

Each of the test computing devices 104 is configured to execute an application under test and, in some embodiments, provide data on user interactions and the interface of the application to the host computing device 102 and/or respond to commands initiated by the host computing device 102. Each test computing device 104 may be embodied as any type of computation or computer device capable of performing the functions described herein, including, without limitation, a mobile computing device, a smartphone, a tablet computer, a wearable computing device, a computer, a laptop computer, a desktop computer, multiprocessor system, a server, a rack-mounted server, a blade server, a network appliance, a web appliance, a distributed computing system, a processor-based system, and/or a consumer electronic device. Each test computing device 104 may include components and devices commonly found in a smartphone or similar computing device, such as a processor 140, an I/O subsystem 142, a memory 144, a data storage device 146, communication circuitry 148, a display 150, and/or other peripheral devices. Those individual components of the test computing device 104 may be similar to the corresponding components of the host computing device 102, the description of which is applicable to the corresponding components of the test computing device 104 and is not repeated herein so as not to obscure the present disclosure.

Additionally, in some embodiments, each test computing device 104 may include a touch screen 152. The touch screen 152 may be embodied as any type of touch screen capable of generating input data in response to being touched by the user of the test computing device 104. The touch screen 152 may be embodied as, for example, a resistive touch screen, a capacitive touch screen, or a camera-based touch screen.

As discussed in more detail below, the host computing device 102 and the test computing devices 104 may be configured to transmit and receive data with each other and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, and switches, to facilitate communications among the devices of the system 100. Additionally or alternatively, the host computing device 102 may communicate directly with one or more test computing devices 104, for example over a direct serial connection, direct USB connection, direct wireless connection, or other direct connection.

Although illustrated as including separate test computing devices 104, it should be understood that in some embodiments, the functions of one or more of the test computing device 104 may be performed by the host computing device 102. For example, the host computing device 102 may execute a platform simulator associated with one or more test computing devices 104.

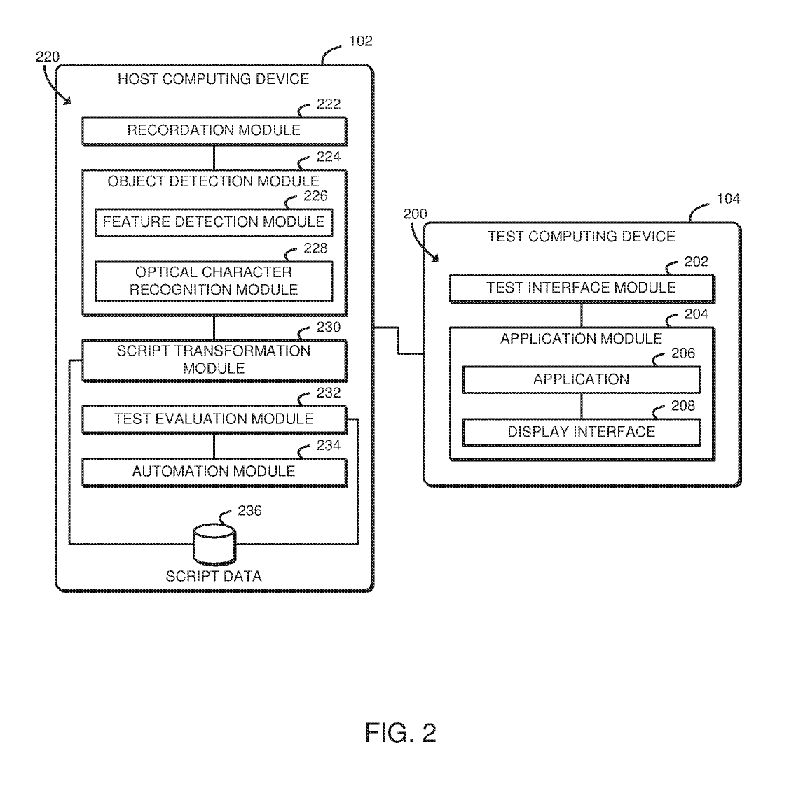

Referring now to FIG. 2, in the illustrative embodiment, a test computing device 104 establishes an environment 200 during operation. The illustrative environment 200 includes a test interface module 202 and an application module 204. The various modules of the environment 200 may be embodied as hardware, firmware, software, or a combination thereof. For example the various modules, logic, and other components of the environment 200 may form a portion of, or otherwise be established by, the processor 140 or other hardware components of the test computing device 104. As such, in some embodiments, any one or more of the modules of the environment 200 may be embodied as a circuit or collection of electrical devices (e.g., a test interface circuit or an application circuit, etc.).

The test interface module 202 is configured to communicate with the host computing device 102 during an application test session. For example, the test interface module 202 may be configured to receive commands from the host computing device 102 to start or stop an application test record session or an application test playback session, and the test interface module 202 may be configured to receive commands from the host computing device 102 corresponding to requested user interface actions. The test interface module 202 may also be configured to transmit information to the host computing device 102, such as user interface event data or display interface data.

The application module 204 is configured to execute an application 206 during an application test session. In some embodiments, the application module 204 may be configured to control the application 206, for example by issuing synthetic user interface events to the application 206. The application 206 may be embodied as computer program executed by the test computing device 104 such as a native application, a web application, a bytecode application, or any other executable application. The particular format, underlying operating system or application toolkit, or other characteristics of the application 206 may depend on the particular test computing device 104 that executes the application 206. During execution, the application 206 creates and/or manages a display interface 208, which may be displayed on the display 150 of the test computing device 104. The display interface 208 may be embodied as any graphical user interface, and may include multiple user interface objects, such as buttons, menu items, text labels, images, or other user interface controls. The size, layout, appearance, language, and other characteristics of the display interface 208 may also depend on the particular test computing device 104 that executes the application 206.

Still referring to FIG. 2, in an illustrative embodiment, the host computing device 102 establishes an environment 220 during operation. The illustrative environment 220 includes a recordation module 222, an object detection module 224, a script transformation module 230, a test evaluation module 232, and an automation module 234. The various modules of the environment 220 may be embodied as hardware, firmware, software, or a combination thereof. For example the various modules, logic, and other components of the environment 220 may form a portion of, or otherwise be established by, the processor 120 or other hardware components of the host computing device 102. As such, in some embodiments, any one or more of the modules of the environment 220 may be embodied as a circuit or collection of electrical devices (e.g., a recordation circuit, an object detection circuit, etc.).

The recordation module 222 is configured to record user interface events generated by a test computing device 104. Each user interface event corresponds to a user interaction with the display interface 208 generated by the application 206 of the test computing device 104. The recordation module 222 is further configured to record video data indicative of the display interface 208 of the test computing device 104. The video data corresponds to the recorded user interface events. The recordation module 222 may be configured to capture the video using screen capture software and/or the camera 132 of the host computing device 102.

The object detection module 224 is configured to detect one or more user interface objects associated with the user interface events in the video data with a computer vision algorithm. The computer vision algorithm may include any appropriate algorithm, such as an image feature detection algorithm and/or an optical character recognition algorithm. The object detection module 224 may be further configured to determine whether a specified user interface object is detected with the computer vision algorithm in a display interface 208 generated by the application 206, for example when executed by a different test computing device 104. In some embodiments, those functions may be performed by one or more sub-modules, such as a feature detection module 226 and/or an optical character recognition module 228.

The script transformation module 230 is configured to generate an object-based test script including one or more object-based script commands. Each object-based script command identifies the user interface object and the associated user interaction. The object-based script command may identify the user interface object using data that may be detected by the object detection module 224 with the computer vision algorithm, such as a reference image. The object-based script commands may be stored in script data 236, for example as a script file or other computer program.

The test evaluation module 232 is configured to read the object-based script commands from the test script (e.g., from the script data 236). As described above, each object-based script command identifies a user interface object and an associated user interaction. The identification of the user interface object may be used by the object detection module 224 to determine whether the user interface object is detected in the display interface 208 of the test computing device 104, as described above. The test evaluation module 232 may be configured to indicate a test success if the user interface object is detected, and to indicate a test failure if the user interface object is not detected. The test evaluation module 232 may be further configured determine an offset of the user interface object based on user input if the user interface object is not detected automatically.

The automation module 234 is configured to perform the user interaction specified by the test script command on the associated user interface object of the application 206 of the test computing device 104. For example, the automation module 234 may be configured to generate a synthetic user selection of the user interface object with the test computing device 104 or to operate the test computing device 104 with a robotic actuator.

Although illustrated as being established by a separate test computing device 104, it should be understood that in some embodiments part or all of the environment 200 may established by the host computing device 102. For example, in some embodiments, the test interface module 202 and/or the application module 204 may be established by the host computing device 102 using a platform simulator associated with one or more test computing devices 104.

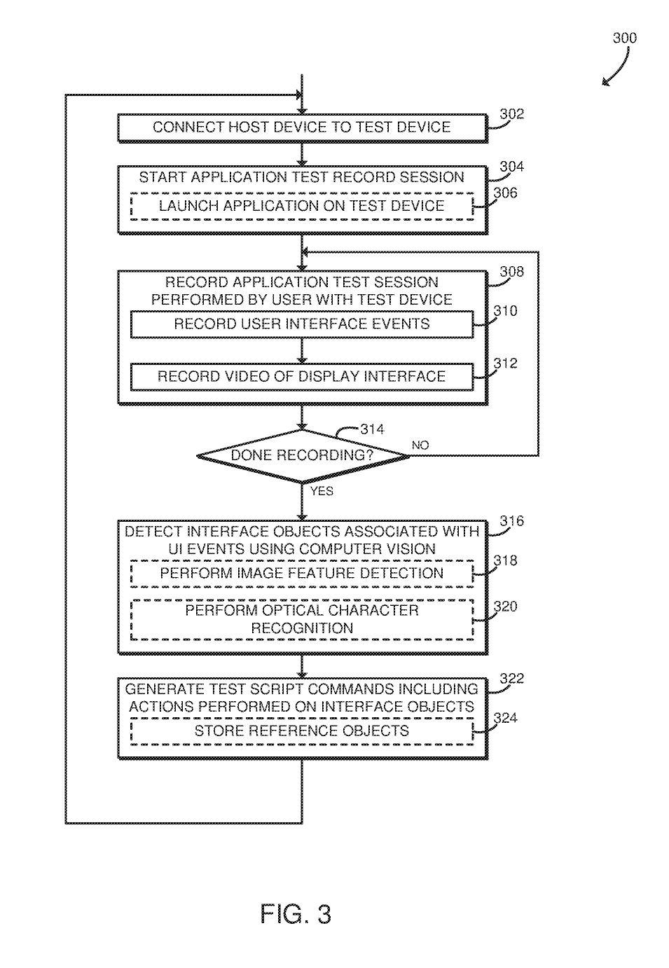

Referring now to FIG. 3, in use, the host computing device 102 may execute a method 300 for recording an object-based test script. The method 300 begins with block 302, in which the host computing device 102 connects to the test computing device 104a. As described above, the host computing device 102 may be directly connected to the test computing device 104a using, for example, a direct serial connection, direct USB connection, or direct wireless connection. In some embodiments, the host computing device 102 may connect to the test computing device 104a using the network 106.

In block 304, the host computing device 102 starts an application test record session for an application 206 executed by the test computing device 104a. The host computing device 102 may perform any configuration, initialization, or other operations required to cause the test computing device 104a to execute the application 206 under test. For example, the host computing device 102 may side-load or otherwise provide the test computing device 104a with binary code corresponding with the application 206. In some embodiments, in block 306, the host computing device 102 may cause the test computing device 104a to launch the application 206. For example, the host computing device 102 may send a message or other command to the test computing device 104a to launch the application 206. In some embodiments, the test computing device 104a may launch the application 206 in a special testing mode or including special testing code (e.g., debugging mode, instrumented execution, etc.). Additionally or alternatively, in some embodiments a user may manually launch the application 206 on the test computing device 104a.

In block 308, the host computing device 102 records an application test session performed by the user with the test computing device 104a. As part of the application test session, the user operates the test computing device 104a, for example to test functions provided by the application 206. The user may select user interface objects in the application 206, enter data, and otherwise interact with the display interface 208 provided by the application 206.

In block 310, the host computing device 102 records user interface events generated by the test computing device 104a. Each user interface event corresponds to a user interaction or group of user interactions with the test computing device 104a. For example, a user interface event may be embodied as a selection event, a mouse click event, a touch event, a keyboard event, or other user interface events. The host computing device 102 may record user interface events at various levels of granularity (e.g., higher level events such as click, tap, swipe, etc., and/or lower-level events such as mouse down, mouse up, touch down, touch up, etc.). The user interface event includes coordinate-based data that may be used to identify a position in the display interface 208 of the application 206 that is associated with the user interface event (e.g., a touch point or a click point). The host computing device 102 may use any technique to record the user interface events; for example, the host computing device 102 may receive the user interface events from a window server, input device driver, or other component of the test computing device 104a. In some embodiments, the host computing device 102 may receive or generate a coordinate-based script file including script commands corresponding to each of the user interface events.

In block 312, the host computing device 102 records a video of the display interface 208 of the application 206 executed by the test computing device 104a. The host computing device 102 may, for example, use the camera 132 to record a video of the contents of the display 150 of the test computing device 104a during execution of the application 206. In some embodiments, the host computing device 102 and/or the test computing device 104a may record the video using high-speed screen capture software to record framebuffer data or other image data representing the display interface 208 generated by the application 206, without using the camera 132.

In block 314, the host computing device 102 determines whether the user is finished recording the application test session. The host computing device 102 may, for example, determine whether the user has terminated the application 206, selected a user interface command to stop recording, or otherwise indicated that the application test session is completed. If the application test record session is not completed, the method 300 loops back to block 308 to continue recording the application test session. If the application test session is completed, the method 300 advances to block 316.

In block 316, the host computing device 102 detects user interface objects associated with the user interface events by analyzing the video data with one or more computer vision algorithms. The user interface objects may include buttons, menu items, text labels, images, or other user interface controls selected or otherwise manipulated by the user. In some embodiments, in block 318 the host computing device 102 may perform image feature detection to detect the user interface object. For example, the host computing device 102 may find the nearest 100 feature points (or another number of feature points) starting from the coordinates of the user interface event (e.g., the touch coordinates). The host computing device 102 may use any appropriate feature detection algorithm, such as SIFT, SURF, and/or AKAZE. In some embodiments, in block 320, the host computing device 102 may perform optical character recognition to detect the user interface object. For example, the host computing device 102 may determine a text label of a button located at the coordinates of the user interface event. Additionally or alternatively, the host computing device 102 may perform any other appropriate algorithm or combination of algorithms to detect the user interface objects. For example, in some embodiments the host computing device 102 may perform general object detection with machine learning.

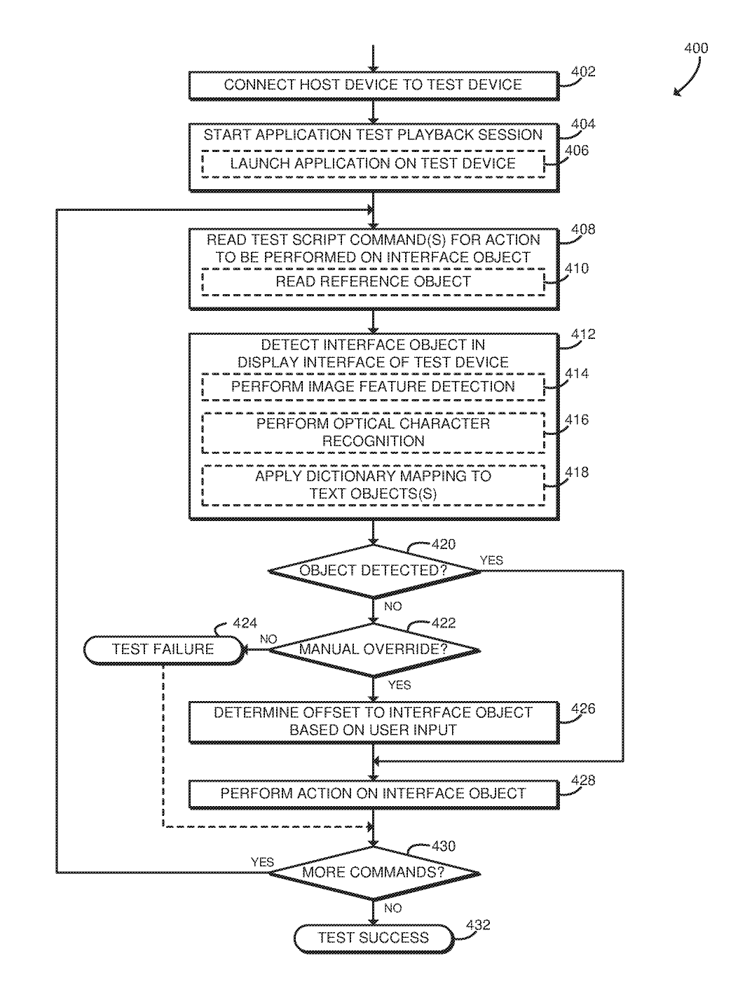

In block 322, the host computing device 102 generates an object-based test script that includes one or more object-based script commands. Each object-based script command specifies an action that is to be performed on an interface object. The specified action may correspond to the recorded user interface events (e.g., touch, click, or other events) and the interface object corresponds to an interface object detected with the computer vision algorithm. The user interface object may be identified using any data produced by the computer vision algorithm as described above in connection with block 316 and/or any data that may be detected by the computer vision algorithm. For example, the host computing device 102 may store image data associated with the user interface object, a text label associated with the user interface object, or other information. In some embodiments, the host computing device 102 may transform a coordinate-based test script into an object-based test script by replacing coordinate-based script commands with object-based script commands. The host computing device 102 may store the object-based test script as a text file, computer program, or other data in the script data 236 and/or in other volatile or non-volatile storage. As described further below in connection with FIG. 4, the object-based test script may later be played back by the host computing device 102 to test the application 206. In some embodiments, in block 324 the host computing device 102 may store one or more reference objects that may be used to identify the user interface objects. For example, the host computing device 102 may store an image file including the nearest 100 feature points associated with the user interface object as described above in connection with block 318.

After generating the object-based test script in block 322, the method 300 loops back to block 302, in which the host computing device 102 may continue recording application test sessions. Additionally or alternatively, although described as sequentially recording the application session, detecting the user interface objects, and generating the object-based test script, it should be understood that the host computing device 102 may perform those operations in any appropriate order or in parallel.

Referring now to FIG. 4, in use, the host computing device 102 may execute a method 400 for playing back an object-based test script. The method 400 begins with block 402, in which the host computing device 102 connects to the test computing device 104b. As described above, the host computing device 102 may be directly connected to the test computing device 104b using, for example, a direct serial connection, direct USB connection, or direct wireless connection. In some embodiments, the host computing device 102 may connect to the test computing device 104b using the network 106.

In block 404, the host computing device 102 starts an application test playback session for an application 206 executed by the test computing device 104b. The host computing device 102 may perform any configuration, initialization, or other operations required to cause the test computing device 104b to execute the application 206. For example, the host computing device 102 may side-load or otherwise provide the test computing device 104b with binary code corresponding with the application 206. In some embodiments, in block 406, the host computing device 102 may cause the test computing device 104b to launch the application 206. For example, the host computing device 102 may send a message or other command to the test computing device 104b to launch the application 206. In some embodiments, the test computing device 104b may launch the application 206 in a special testing mode or including special testing code (e.g., debugging mode, instrumented execution, etc.). Additionally or alternatively, in some embodiments a user may manually launch the application 206 on the test computing device 104b.

In block 408, the host computing device 102 reads one or more test script commands to identify a user interface action to be performed on a user interface object. The host computing device 102 may read the test script commands from the script data 236 that includes a test script previously recorded by the host computing device 102 as described above in connection with FIG. 3. Thus, the test script may have been recorded using a test computing device 104a that is different from the test computing device 104b of the current application test playback session. In some embodiments, the test computing devices 104a, 104b may have different form factors (e.g., different display 150 sizes, aspect ratios, and/or resolutions), different user input devices, and other different hardware. In some embodiments, the test computing devices 104a, 104b may have different software environments (e.g., different operating systems, different application toolkits, different language settings, etc.). Of course, although illustrated as recording and playing back the test script on different test computing devices 104a, 104b, it should be understood that in some embodiments the test script may be recorded and played hack using the same test computing device 104. In some embodiments, in block 410 the host computing device 102 reads a reference object associated with the test script command. For example, the host computing device 102 may read a reference image file associated with the user interface object.

In block 412, the host computing device 102 detects the user interface object in the display interface 208 generated by the application 206 of the test computing device 104b. As described above, user interface objects may include buttons, menu items, text labels, images, or other user interface controls that may be selected or otherwise manipulated by the user. The host computing device 102 detects the user interface object by performing one or more computer vision algorithms on image data of the display interface 208. Detecting the user interface object may include determining coordinates and/or bounds within the display interface 208 associated with the user interface object.

In some embodiments, in block 414 the host computing device 102 may perform image feature detection to detect the user interface object. For example, the computing device may find image data within the display interface 208 having features matching a reference image associated with the test script. As described above, the host computing device 102 may use any appropriate feature detection algorithm, such as SIFT, SURF, and/or AKAZE.

In some embodiments, in block 416, the host computing device 102 may perform optical character recognition to detect the user interface object. For example, the host computing device 102 may determine the text labels for buttons or other user interface objects in the display interface 208 and search for a text label matching a text label associated with the test script. In some embodiments, in block 418 the host computing device 102 may apply a dictionary mapping to the text data associated with the test script and/or the display interface 208 when searching for the user interface object. For example, the text may be mapped to another natural language (e.g., translated from English to Chinese) to test an application 206 that has been localized or otherwise translated into a different language.

In block 420, the host computing device 102 determines whether the user interface object was successfully detected in the display interface 208. If so, the method 400 branches ahead to block 428, described below. If the user interface object was not detected, the method 400 advances to block 422.

In block 422, the host computing device 102 determines whether to allow manual override of user interface object detection. As described below, manual override may allow the user of the host computing device 102 to manually designate the appropriate user interface object. To determine whether to allow manual override, the host computing device 102 may, for example, prompt the user whether to perform manual override. In some embodiments, the host computing device 102 may not support manual override and thus may always determine not to allow manual override. If the host computing device 102 allows manual override, the method 400 advances to block 426, described below. If the host computing device 102 does not allow manual override, the method 400 branches to block 424, in which the host computing device 102 may indicate a test failure. The host computing device 102 may use any technique to indicate the failure, such as notifying the user, executing a failure script command, and/or logging the error. After indicating the test failure, the method 400 may be completed. In some embodiments, after indicated the test failure, the method 400 may branch ahead to block 430 to process additional test script commands, as described below.

Referring back to block 422, if manual override is available, the method 400 advances to block 426, in which the host computing device 102 determines an offset to the user interface object based on user input. The manually specified offset may allow the host computing device 102 to identify user interface objects that change appearance (e.g., graphical appearance, text label, etc.) but maintain the same relative position to identifiable features of the display interface 208. For example, the host computing device 102 may determine a relative offset to a user selection from an identifiable feature of the display interface 208 such as a graphical image. As another example, the host computing device 102 may determine an absolute offset based on the position of the user selection within the display interface 208 and/or display 150 of the test computing device 104b. After determining the offset, the method 400 advances to block 428.

Referring back to block 420, if the user interface object is detected, then the method 400 branches ahead to block 428, in which the host computing device 102 performs the action specified by the test script command(s) on the user interface object. The host computing device 102 may perform any appropriate user interface action described in the test script command. For example, the host computing device 102 may perform a touch event, perform a mouse click, perform a key press, wait for a predetermined time, or perform another user interface action. In some embodiments, the host computing device 102 may cause the test computing device 104b to generate a synthetic user interface event, for example by transmitting a command to the test computing device 104b. Additionally or alternatively, the host computing device 102 may perform the user interface action by operating the test computing device 104b using a robotic actuator. For example, the host computing device 102 may touch the user interface object on the touch screen 152 of the test computing device 104b using a robotic finger.

In block 430, the host computing device 102 determines whether additional test script commands remain in the test script. If so, the method 400 loops back to block 408 to continue processing test script commands. If no additional test script commands remain, the method 400 advances to block 432, in which the host computing device 102 may indicate a test success. The host computing device 102 may use any technique to indicate the success, such as notifying the user, executing a success script command, and/or logging the success. After indicating the test success, the method 400 may be completed. The host computing device 102 may repeatedly perform the method 400 to test additional test computing devices 104 and/or additional applications 206.

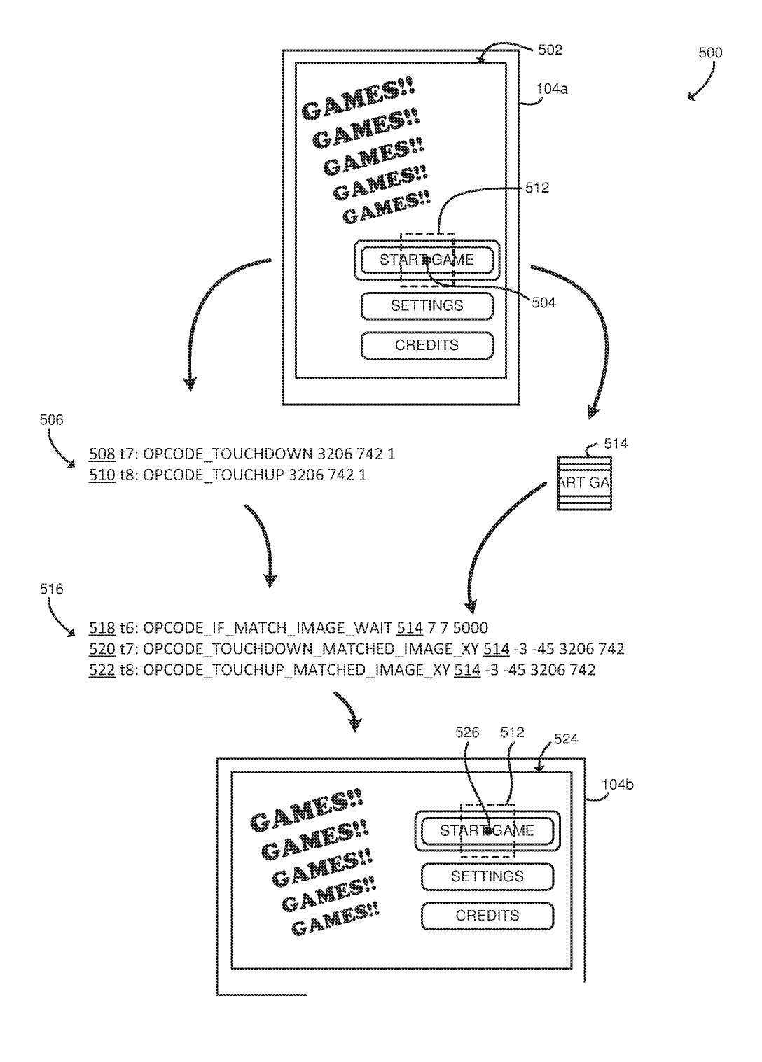

Referring now to FIG. 5, a schematic diagram 500 illustrates the operation of one potential embodiment of the system 100 for device-independent application testing. As described above in connection with FIG. 3, the host computing device 102 may record an application test session executed by the test computing device 104a. In the illustrative embodiment, the application 206 of the test computing device 104a is a game that generates a display interface 502. As shown, the display interface 502 includes several user interface objects including custom graphics and buttons.

While recording the application test session, the user touches the display interface 502 at the point 504. As described above, the test computing device 104a may generate one or more user interface events associated with that touch event. In the illustrative embodiment, the test computing device 104a generates a touch down event and a touch up event, which are illustrated by the coordinate-based test script 506. Each statement of the illustrative coordinate-based test script 506 includes a numeric label, a timestamp, an opcode, and parameters associated with the opcode. Thus, the illustrative coordinate-based test script 506 includes statements 508, 510 having opcodes OPCODE_TOUCHDOWN and OPCODE_TOUCHUP, which correspond to the touch down and touch up events generated by the test computing device 104a, respectively. In the illustrative embodiment, the parameters of the statements 508, 510 represent normalized absolute coordinates of the touch point 504 within the display interface 502.

As described above in connection with block 316 of FIG. 3, the host computing device 102 analyzes video data of the display interface 502 to identify user interface objects associated with user interface events. In the illustrative embodiment, the host computing device 102 performs an image feature detection algorithm to identify a region 512 of the display interface 502 that includes the 100 feature points nearest to the touch point 504. The host computing device 102 may extract the region 512 to generate a reference image 514 corresponding to the user interface object. Additionally or alternatively, the host computing device 102 may perform optical character recognition to identify the user interface object including the touch point 504. For example, in the illustrative embodiment the host computing device 102 may determine that the user interface object is represented by the text label “START GAME.”

As described above in connection with block 322 of FIG. 3, the host computing device 102 generates an object-based test script 516 based on the recorded user interface events and detected user interface objects. In the illustrative embodiment, the object-based test script 516 uses syntax similar to the coordinate-based test script 506, but includes one or more object-based opcodes. For example, in the illustrative embodiment statement 518 includes the opcode OPCODE_IF_MATCH_IMAGE_WAIT, which corresponds to determining whether a reference image is displayed by the application 206 within a specified time limit and branching to specified script statements based on whether the reference mage is detected. In the illustrative embodiment, the statement 518 corresponds to detecting the reference image 514 within a time limit of 5000 milliseconds, and indicates that statement 520 should be executed whether the image is detected or not. Of course, in some embodiments alternate statements (such as error reporting, manual override, or other functions) may be executed if the image is not detected. Additionally or alternatively, the object-based test script may correspond to using other algorithms or combinations of multiple algorithms to match the user interface objects. For example, a script command may include text data for identifying the user interface object using an optical character recognition algorithm (e.g., the text data “START GAME” in the illustrative embodiment).

The statement 520 of the object-based test script 516 includes the opcode OPCODE_TOUCHDOWN_MATCHED_IMAGE_XY, which corresponds to generating a touch down event at a particular coordinate relative to a matched reference image. In the illustrative embodiment, statement 520 corresponds to generating a touch down event at the coordinates −3, −45 relative to the reference image 514. The statement 520 also includes normalized absolute coordinates that may be used if the reference image 514 is not detected. Statement 522 includes the opcode OPCODE_TOUCHUP_MATCHED_IMAGE_XY, which similarly corresponds to generating a touch up event at the specified coordinate relative to the matched reference image.

As described above in connection with FIG. 4, the host computing device 102 may play back the object-based test script 516 to test the application 206 on a test computing device 104b that is different from the test computing device 104a that was used to record the object-based test script 516. In the illustrative embodiment, during playback the application 206 of the test computing device 104b generates a display interface 524. As shown, the display interface 524 has a different aspect ratio compared to the original display interface 502 and thus has a different layout of user interface objects. As described above, in other embodiments the display interfaces 502, 524 may also have a different size, resolution, or other characteristics.

While playing back the object-based test script 516, the host computing device 102 reads script commands and analyzes the display interface 524 to identify user interface objects. For example, the host computing device 102 may read statement 518 and then analyze the display interface 524 to locate the region 512 matching the reference image 514. After matching the reference image 514, the host computing device 102 may read statement 520 and then generate a touch down event at a touch point 526 within the region 512 that matches the reference image 514. As shown, the touch point 526 has different absolute coordinates compared to the original touch point 504. Similarly, the host computing device 102 may read statement 522 and then generate a touch up event at the touch point 526. Thus, the test computing device 104b may continue to execute the application 206 based on the user interface actions generated by the host computing device 102.

Additionally or alternatively, in some embodiments the host computing device 102 may use other algorithms or combinations of algorithms to match the user interface objects specified in the object-based test script 516. For example, in some embodiments the host computing device 102 may perform optical character recognition on the display interface 524 to detect a specified user interface object. Thus, in the illustrative embodiment, the host computing device 102 may search for the text data “START GAME” in the display interface 524. As described above, in some embodiments the host computing device 102 may translate the text data of the object-based test script and/or the display interface 524 into an alternate language that may be used to match the user interface object.

### EXAMPLES

illustrative examples of the technologies disclosed herein are provided below. An embodiment of the technologies may include any one or more, and any combination of, the examples described below.

Example 1 includes a computing device for application testing, the computing device comprising a recordation module to (i) record a user interface event generated by a test computing device, wherein the user interface event corresponds to a user interaction with a display interface generated by an application of the test computing device and (ii) record video data indicative of the display interface of the test computing device, wherein the video data corresponds to the user interface event; an object detection module to detect a user interface object in the video data, wherein the user interface object is associated with the user interface event; and a script transformation module to generate an object-based script command, wherein the object-based script command identifies the user interface object and the user interaction.

Example 2 includes the subject matter of Example 1, and wherein the user interface event comprises a user selection event.

Example 3 includes the subject matter of any of Examples 1 and 2, and wherein the user selection event comprises a touch event, a click event, or a pointing event.

Example 4 includes the subject matter of any of Examples 1-3, and wherein to detect the user interface object in the video data comprises to detect the user interface object with an image feature detection computer vision algorithm.

Example 5 includes the subject matter of any of Examples 1-4, and wherein to generate the object-based script command comprises to store image data associated with the user interface object.

Example 6 includes the subject matter of any of Examples 1-5, and wherein to detect the user interface object in the video data comprises to detect the user interface object with an optical character recognition computer vision algorithm.

Example 7 includes the subject matter of any of Examples 1-6, and wherein to generate the object-based script command comprises to store text data associated with the user interface object.

Example 8 includes the subject matter any of Examples 1-7, and wherein to record the video data comprises to record the video data with a camera of the computing device.

Example 9 includes the subject matter of any of Examples 1-8, and wherein the object detection module is further to determine whether the user interface object is detected in a second display interface generated by an application of a second test computing device; and the computing device further comprises an automation module to perform the user interaction on the user interface object of the application of the second test computing device in response to a determination that the user interface object is detected.

Example 10 includes the subject matter of any of Examples 1-9, and further including a test evaluation module to indicate a test success in response to performance of the user interaction.

Example 11 includes the subject matter of any of Examples 1-10, and further including a test evaluation module to indicate a test failure in response to a determination that the user interface object is not detected.

Example 12 includes the subject matter of any of Examples 1-11, and further including a test evaluation module to determine an offset of the user interface object based on user input in response to a determination that the user interface object is not detected; wherein to perform the user interaction further comprises to perform the user interaction based on the offset of the user interface object.

Example 13 includes the subject matter of any of Examples 1-12, and wherein the recordation module is further to capture the second display interface of the second test computing device with a camera of the computing device; and to determine whether the user interface object is detected comprises to determine whether the user interface object is detected in response to capture of the second display interface of the second test computing device.

Example 14 includes the subject matter of any of Examples 1-13, and wherein to determine whether the user interface object is detected further comprises to map text data associated with the user interface object to second text data using a dictionary mapping.

Example 15 includes the subject matter of any of Examples 1-14, and wherein to perform the user interaction on the user interface object of the application of the second test computing device comprises to generate a synthetic user selection of the user interface object with the second test computing device.

Example 16 includes the subject matter of any of Examples 1-15, and wherein to perform the user interaction on the user interface object of the application of the second test computing device comprises to operate the second test computing device with a robotic actuator.

Example 17 includes a computing device for application testing, the computing device comprising a test evaluation module to read an object-based script command from a test script, wherein the object-based script command identifies a user interface object and a user interaction; an object detection module to determine whether the user interface object is detected in a display interface generated by an application of a test computing device; and an automation module to perform the user interaction on the user interface object of the application of the test computing device in response to a determination that the user interface object is detected.

Example 18 includes the subject matter of Example 17, and wherein the test evaluation module is further to indicate a test success in response to performance of the user interaction.

Example 19 includes the subject matter of any of Examples 17 and 18, and wherein the test evaluation module is further to indicate a test failure in response to a determination that the user interface object is not detected.

Example 20 includes the subject matter of any of Examples 17-19, and wherein the test evaluation module is further to determine an offset of the user interface object based on user input in response to a determination that the user interface object is not detected; and to perform the user interaction further comprises to perform the user interaction based on the offset of the user interface object.

Example 21 includes the subject matter of any of Examples 17-20, and further including a recordation module to capture the display interface of the test computing device with a camera of the computing device; wherein to determine whether the user interface object is detected comprises to determine whether the user interface object is detected in response to capture of the display interface of the test computing device.

Example 22 includes the subject matter of any of Examples 17-21, and wherein to determine whether the user interface object is detected in the display interface comprises to determine whether the user interface object is detected in the display interface with an image feature detection computer vision algorithm.

Example 23 includes the subject matter of any of Examples 17-22, and wherein to determine whether the user interface object is detected in the display interface comprises to determine whether the user interface object is detected in the display interface with an optical character recognition computer vision algorithm.

Example 24 includes the subject matter of any of Examples 17-23, and wherein to determine whether the user interface object is detected further comprises to map text data associated with the user interface object to second text data using a dictionary mapping.

Example 25 includes the subject matter of any of Examples 17-24, and wherein to perform the user interaction on the user interface object of the application of the test computing device comprises to generate a synthetic user selection of the user interface object with the test computing device.

Example 26 includes the subject matter of any of Examples 17-25, and wherein to perform the user interaction on the user interface object of the application of the test computing device comprises to operate the test computing device with a robotic actuator.

Example 27 includes a method for application testing, the method comprising recording, by a computing device, a user interface event generated by a test computing device, wherein the user interface event corresponds to a user interaction with a display interface generated by an application of the test computing device; recording, by the computing device, video data indicative of the display interface of the test computing device, wherein the video data corresponds to the user interface event; detecting, by the computing device, a user interface object in the video data, wherein the user interface object is associated with the user interface event; and generating, by the computing device, an object-based script command, wherein the object-based script command identifies the user interface object and the user interaction.

Example 28 includes the subject matter of Example 27, and wherein recording the user interface event comprises recording a user selection of the user interface object.

Example 29 includes the subject matter of any of Examples 27 and 28, and wherein recording the user selection comprises recording a touch event, a click event, or a pointing event.

Example 30 includes the subject matter of any of Examples 27-29, and wherein detecting the user interface object comprises performing an image feature detection computer vision algorithm.

Example 31 includes the subject matter of any of Examples 27-30, and wherein generating the object-based script command comprises storing image data associated with the user interface object.

Example 32 includes the subject matter of any of Examples 27-31, and wherein detecting the user interface object comprises performing an optical character recognition computer vision algorithm.

Example 33 includes the subject matter of any of Examples 27-32, and wherein generating the object-based script command comprises storing text data associated with the user interface object.

Example 34 includes the subject matter of any of Examples 27-33, and wherein recording the video data comprises recording the video data with a camera of the computing device.

Example 35 includes the subject matter of any of Examples 27-34, and further including determining, by the computing device, whether the user interface object is detected in a second display interface generated by an application of a second test computing device; and performing, by the computing device, the user interaction on the user interface object of the application of the second test computing device response to determining that the user interface object is detected.

Example 36 includes the subject matter of any of Examples 27-35, and further including indicating, by the computing device, a test success in response to performing the user interaction.

Example 37 includes the subject matter of any of Examples 27-36, and, further including indicating, by the computing device, a test failure in response to determining that the user interface object is not detected.

Example 38 includes the subject matter of any of Examples 27-37, and further including determining, by the computing device, an offset of the user interface object based on user input in response to determining the user interface object is not detected; wherein performing the user interaction further comprises performing the user interaction based on the offset of the user interface object.

Example 39 includes the subject matter of any of Examples 27-38, and further including capturing, by the computing device, the second display interface of the second test computing device with a camera of the computing device; wherein determining whether the user interface object is detected comprises determining whether the user interface object is detected in response to capturing the second display interface of the second test computing device.

Example 40 includes the subject matter of any of Examples 27-39, and wherein determining whether the user interface object is detected further comprises mapping text data associated with the user interface object to second text data using a dictionary mapping.

Example 41 includes the subject matter of any of Examples 27-40, and wherein performing the user interaction on the user interface object of the application of the second test computing device comprises generating a synthetic user selection of the user interface object with the second test computing device.

Example 42 includes the subject matter of any of Examples 27-41, and wherein performing the user interaction on the user interface object of the application of the second test computing device comprises operating the second test computing device with a robotic actuator.

Example 43 includes a method for application testing, the method comprising reading, by a computing device, an object-based script command from a test script, wherein the object-based script command identifies a user interface object and a user interaction; determining, by the computing device, whether the user interface object is detected in a display interface generated by an application of a test computing device; and performing, by the computing device, the user interaction on the user interface object of the application of the test computing device in response to determining that the user interface object is detected.

Example 44 includes the subject matter of Example 43, and further including indicating, by the computing device, a test success in response to performing the user interaction.

Example 45 includes the subject matter of any of Examples 43 and 44, and further including indicating, by the computing device, a test failure in response to determining that the user interface object is not detected.

Example 46 includes the subject matter of any of Examples 43-45, and further including determining, by the computing device, an offset of the user interface object based on user input in response to determining that the user interface object is not detected; wherein performing the user interaction further comprises performing the user interaction based on the offset of the user interface object.

Example 47 includes the subject matter of any of Examples 43-46, and further including capturing, by the computing device, the display interface of the test computing device with a camera of the computing device; wherein determining whether the user interface object is detected comprises determining whether the user interface object is detected in response to capturing the display interface of the test computing device.

Example 48 includes the subject matter of any of Examples 43-47, and wherein determining whether the user interface object is detected comprises performing an image feature detection computer vision algorithm.

Example 49 includes the subject matter of any of Examples 43-48, and wherein determining whether the user interface object is detected comprises performing an optical character recognition computer vision algorithm.

Example 50 includes the subject matter of any of Examples 43-49, and wherein determining whether the user interface object is detected further comprises mapping text data associated with the user interface object to second text data using a dictionary mapping.

Example 51 includes the subject matter of any of Examples 43-50, and wherein performing the user interaction on the user interface object of the application of the test computing device comprises generating a synthetic user selection of the user interface object with the test computing device.

Example 52 includes the subject matter of any of Examples 43-51, and wherein performing the user interaction on the user interface object of the application of the test computing device comprises operating the test computing device with a robotic actuator.

Example 53 includes a computing device comprising a processor; and a memory having stored therein a plurality of instructions that when executed by the processor cause the computing device to perform the method of any of claims 27-52.

Example 54 includes one or more machine readable storage media comprising a plurality of instructions stored thereon that in response to being executed result in a computing device performing the method of any of Examples 27-52.

Example 55 includes a computing device comprising means for performing the method of any of Examples 27-52.

Example 56 includes a computing device for application testing, the computing device comprising means for recording a user interface event generated by a test computing device, wherein the user interface event corresponds to a user interaction with a display interface generated by an application of the test computing device; means for recording video data indicative of the display interface of the test computing device, wherein the video data corresponds to the user interface event; means for detecting a user interface object in the video data, wherein the user interface object is associated with the user interface event; and means for generating an object-based script command., wherein the object-based script command identifies the user interface object and the user interaction.

Example 57 includes the subject matter of Example 56, and wherein the means for recording the user interface event comprises means for recording a user selection of the user interface object.

Example 58 includes the subject matter of any of Examples 56 and 57, and wherein the means for recording the user selection comprises means for recording a touch event, a click event, or a pointing event.

Example 59 includes the subject matter of any of Examples 56-58, and wherein the means for detecting the user interface object comprises means for performing an image feature detection computer vision algorithm.

Example 60 includes the subject matter of any of Examples 56-59, and wherein the means for generating the object-based script command comprises means for storing image data associated with the user interface object.

Example 61 includes the subject matter of any of Examples 56-60, and, wherein the means for detecting the user interface object comprises means for performing an optical character recognition computer vision algorithm.

Example 62 includes the subject matter of any of Examples 56-61, and wherein the means for generating the object-based script command comprises means for storing text data associated with the user interface object.

Example 63 includes the subject matter of any of Examples 56-62, and wherein the means for recording the video data comprises means for recording the video data with a camera of the computing device.

Example 64 includes the subject matter of any of Examples 56-63, and further including means for determining whether the user interface object is detected in a second display interface generated by an application of a second test computing device; and means for performing the user interaction on the user interface object of the application of the second test computing device in response to determining that the user interface object is detected.

Example 65 includes the subject matter of any of Examples 56-64, and further including indicating, by the computing device, a test success in response to performing the user interaction.

Example 66 includes the subject matter of any of Examples 56-65, and further including means for indicating a test failure in response to determining that the user interface object is not detected.

Example 67 includes the subject matter of any of Examples 56-66, and further including means for determining an offset of the user interface object based on user input in response to determining the user interface object is not detected; wherein the means for performing the user interaction further comprises means for performing the user interaction based on the offset of the user interface object.

Example 68 includes the subject matter of any of Examples 56-67, and further including means for capturing the second display interface of the second test computing device with a camera of the computing device; wherein the means for determining whether the user interface object is detected comprises means for determining whether the user interface object is detected in response to capturing the second display interface of the second test computing device.

Example 69 includes the subject matter of any of Examples 56-68, and wherein the means for determining whether the user interface object is detected further comprises means for mapping text data associated with the user interface object to second text data using a dictionary mapping.

Example 70 includes the subject matter of any of Examples 56-69, and wherein the means for performing the user interaction on the user interface object of the application of the second test computing device comprises means for generating a synthetic user selection of the user interface object with the second test computing device.

Example 71 includes the subject matter of any of Examples 56-70, and wherein the means for performing the user interaction on the user interface object of the application of the second test computing device comprises means for operating the second test computing device with a robotic actuator.

Example 72 includes a computing device for application testing, the computing device comprising means for reading an object-based script command from a test script, wherein the object-based script command identifies a user interface object and a user interaction; means for determining whether the user interface object is detected in a display interface generated by an application of a test computing device; and means for performing the user interaction on the user interface object of the application of the test computing device in response to determining that the user interface object is detected.

Example 73 includes the subject matter of Example 72, and further including means for indicating a test success in response to performing the user interaction.

Example 74 includes the subject matter of any of Examples 72 and 73, and further including means for indicating a test failure in response to determining that the user interface object is not detected.

Example 75 includes the subject matter of any of Examples 72-74, and further including means for determining an offset of the user interface object based on user input in response to determining that the user interface object is not detected; wherein the means for performing the user interaction further comprises means for performing the user interaction based on the offset of the user interface object.

Example 76 includes the subject matter of any of Examples 72-75, and further including means for capturing the display interface of the test computing device with a camera of the computing device; wherein the means for determining whether the user interface object is detected comprises means for determining whether the user interface object is detected in response to capturing the display interface of the test computing device.

Example 77 includes the subject matter of any of Examples 72-76, and wherein the means for determining whether the user interface object is detected comprises means for performing an image feature detection computer vision algorithm.

Example 78 includes the subject matter of any of Examples 72-77, and wherein the means for determining whether the user interface object is detected comprises means for performing an optical character recognition computer vision algorithm.

Example 79 includes the subject matter of any of Examples 72-78, and wherein the means for determining whether the user interface object is detected further comprises means for mapping text data associated with the user interface object to second text data using a dictionary mapping.

Example 80 includes the subject matter of any of Examples 72-79, and wherein the means for performing the user interaction on the user interface object of the application of the test computing device comprises means for generating a synthetic user selection of the user interface object with the test computing device.

Example 81 includes the subject matter of any of Examples 72-80, and wherein the means for performing the user interaction on the user interface object of the application of the test computing device comprises means for operating the test computing device with a robotic actuator.

1-25. (canceled)

26. A computing device for application testing, the computing device comprising:
a recordation module to (i) record a user interface event generated by a test computing device, wherein the user interface event corresponds to a user interaction with a display interface generated by an application of the test computing device and (ii) record video data indicative of the display interface of the test computing device, wherein the video data corresponds to the user interface event;
an object detection module to detect a user interface object in the video data, wherein the user interface object is associated with the user interface event; and
a script transformation module to generate an object-based script command, wherein the object-based script command identifies the user interface object and the user interaction.

27. The computing device of claim 26, wherein the user interface event comprises a user selection event.

28. The computing device of claim 26, wherein to detect the user interface object in the video data comprises to detect the user interface object with an image feature detection computer vision algorithm.

29. The computing device of claim 26, wherein to detect the user interface object in the video data comprises to detect the user interface object with an optical character recognition computer vision algorithm.

30. The computing device of claim 26, wherein to record the video data comprises to record the video data with a camera of the computing device.

31. The computing device of claim 26, wherein:
the object detection module is further to determine whether the user interface object is detected in a second display interface generated by an application of a second test computing device; and
the computing device further comprises an automation module to perform the user interaction on the user interface object of the application of the second test computing device in response to a determination that the user interface object is detected.

32. The computing device of claim 31, wherein to determine whether the user interface object is detected further comprises to map text data associated with the user interface object to second text data using a dictionary mapping.

33. The computing device of claim 31, wherein to perform the user interaction on the user interface object of the application of the second test computing device comprises to operate the second test computing device with a robotic actuator.

34. One or more computer-readable storage media comprising a plurality of instructions that in response to being executed cause a computing device to:
record a user interface event generated by a test computing device, wherein the user interface event corresponds to a user interaction with a display interface generated by an application of the test computing device;
record video data indicative of the display interface of the test computing device, wherein the video data corresponds to the user interface event;
detect a user interface object in the video data, wherein the user interface object is associated with the user interface event; and
generate an object-based script command, wherein the object-based script command identifies the user interface object and the user interaction.

35. The one or more computer-readable storage media of claim 34, wherein to detect the user interface object comprises to perform an image feature detection computer vision algorithm.

36. The one or more computer-readable storage media of claim 34, wherein to detect the user interface object comprises to perform an optical character recognition computer vision algorithm.

37. The one or more computer-readable storage media of claim 34, further comprising a plurality of instructions that in response to being executed cause the computing device to:
determine whether the user interface object is detected in a second display interface generated by an application of a second test computing device; and
perform the user interaction on the user interface object of the application of the second test computing device in response to determining that the user interface object is detected.

38. The one or more computer-readable storage media of claim 37, wherein to determine whether the user interface object is detected further comprises to map text data associated with the user interface object to second text data using a dictionary mapping.

39. The one or more computer-readable storage media of claim 37, wherein to perform the user interaction on the user interface object of the application of the second test computing device comprises to operate the second test computing device with a robotic actuator.

40. A computing device for application testing, the computing device comprising:
a test evaluation module to read an object-based script command from a test script, wherein the object-based script command identifies a user interface object and a user interaction;
an object detection module to determine whether the user interface object is detected in a display interface generated by an application of a test computing device; and
an automation module to perform the user interaction on the user interface object of the application of the test computing device in response to a determination that the user interface object is detected.

41. The computing device of claim 40, wherein:
the test evaluation module is further to determine an offset of the user interface object based on user input in response to a determination that the user interface object is not detected; and
to perform the user interaction further comprises to perform the user interaction based on the offset of the user interface object.

42. The computing device of claim 40, wherein to determine whether the user interface object is detected in the display interface comprises to determine whether the user interface object is detected in the display interface with an image feature detection computer vision algorithm.

43. The computing device of claim 40, wherein to determine whether the user interface object is detected in the display interface comprises to determine whether the user interface object is detected in the display interface with an optical character recognition computer vision algorithm.

44. The computing device of claim 43, wherein to determine whether the user interface object is detected further comprises to map text data associated with the user interface object to second text data using a dictionary mapping.

45. The computing device of claim 40, wherein to perform the user interaction on the user interface object of the application of the test computing device comprises to operate the test computing device with a robotic actuator.

46. One or more computer-readable storage media comprising a plurality of instructions that in response to being executed cause a computing device to:
read an object-based script command from a test script, wherein the object-based script command identifies a user interface object and a user interaction;
determine whether the user interface object is detected in a display interface generated by an application of a test computing device; and
perform the user interaction on the user interface object of the application of the test computing device in response to determining that the user interface object is detected.

47. The one or more computer-readable storage media of claim 46, further comprising a plurality of instructions that in response to being executed cause the computing device to:
determine an offset of the user interface object based on user input in response to determining that the user interface object is not detected;
wherein to perform the user interaction further comprises to perform the user interaction based on the offset of the user interface object.

48. The one or more computer-readable storage media of claim 46, wherein to determine whether the user interface object is detected comprises to perform an image feature detection computer vision algorithm.

49. The one or more computer-readable storage media of claim 46, wherein to determine whether the user interface object is detected comprises to perform an optical character recognition computer vision algorithm.

50. The one or more computer-readable storage media of claim 46, wherein to perform the user interaction on the user interface object of the application of the test computing device comprises to operate the test computing device with a robotic actuator.
